(19) United States
(12) Patent Application Publication
(10) Pub. No.: US 2022/0237434 A1
(43) Pub. Date: Jul. 28, 2022

(54) ELECTRONIC APPARATUS FOR PROCESSING MULTI-MODAL DATA, AND OPERATION METHOD THEREOF

(71) Applicant: SAMSUNG ELECTRONICS CO., LTD., Suwon-si (KR)

(72) Inventor: Jeonghoe KU, Suwon-si (KR)

(73) Assignee: SAMSUNG ELECTRONICS CO., LTD., Suwon-si (KR)

(21) Appl. No.: 17/711,316

(22) Filed: Apr. 1, 2022

Related U.S. Application Data
(63) Continuation of application No. PCT/KR2022/000977, filed on Jan. 19, 2022.

(30) Foreign Application Priority Data
Jan. 25, 2021 (KR) 10-2021-0010353

(51) Int. Cl. G06N 3/04; G06N 3/08

(52) U.S. Cl. CPC G06N 3/0445; G06N 3/08

(57) ABSTRACT

An electronic apparatus for performing a preset task by using a deep neural network (DNN), the electronic apparatus includes an input interface configured to receive input data of a first type and input data of a second type; and a processor configured to obtain first sub-feature information corresponding to the input data of the first type and second sub-feature information corresponding to the input data of the second type; obtain feature information from each of a plurality of layers of the DNN by inputting the first sub-feature information and the second sub-feature information into the DNN; calculate a weight for each type corresponding to each of the plurality of layers, based on the feature information, the first sub-feature information, and the second sub-feature information; and obtain a final output value corresponding to the preset task by applying the weight for each type, in each of the plurality of layers.

### CROSS-REFERENCE TO RELATED APPLICATIONS

This application is a Continuation Application of International Application No. PCT/KR2022/000977, filed on Jan. 19, 2022, which claims benefit of priority to Korean Patent Application No. 10-2021-0010353, filed on Jan. 25, 2021, in the Korean Intellectual Property Office, the disclosures of which are incorporated herein in their entireties by reference.

### BACKGROUND

### 1. Field

The disclosure relates to an electronic apparatus for processing multi-modal data, and more particularly, to an electronic apparatus for performing a specific task by using pieces of input data of different types, and an operation method thereof.

### 2. Description of Related Art

Deep learning is a machine learning technology that enables computing systems to perform human-like actions. As deep learning network technology develops, research on technology that performs a specific task by receiving inputs of various types, for example, an input of an image mode, an input of a text mode, and the like, is being actively conducted. Recently, technologies that may improve network performance by considering the importance of each mode with respect to inputs of various types are being discussed. In order to accurately and quickly perform tasks with respect to inputs of various types, a device capable of generating a weight reflecting the importance of each mode is desired.

### SUMMARY

Provided are an electronic apparatus for processing multi-modal data by calculating importance with respect to inputs of different types and generating a weight for each mode reflecting the calculated importance, and an operation method thereof.

According to an aspect of the disclosure, an electronic apparatus for performing a preset task by using a deep neural network (DNN) may include an input interface configured to receive input data of a first type and input data of a second type; a memory storing one or more instructions; and a processor configured to execute the one or more instructions stored in the memory to: obtain first sub-feature information corresponding to the input data of the first type and second sub-feature information corresponding to the input data of the second type; obtain feature information from each of a plurality of layers of the DNN by inputting the first sub-feature information and the second sub-feature information into the DNN; calculate a weight for each type corresponding to each of the plurality of layers, based on the feature information, the first sub-feature information, and the second sub-feature information; and obtain a final output value corresponding to the preset task by applying the weight for each type, in each of the plurality of layers.

The processor may be further configured to: obtain the first sub-feature information by inputting the input data of the first type into a pre-trained first sub-network; and obtain the second sub-feature information by inputting the input data of the second type into a pre-trained second sub-network.

The processor may be further configured to: encode, based on type identification information that distinguishes a type of the input data, the first sub-feature information and the second sub-feature information; and input the encoded first sub-feature information and the encoded second sub-feature information to the DNN.

The processor may be further configured to encode the first sub-feature information and the second sub-feature information by concatenating the first sub-feature information and the second sub-feature information.

The processor may be further configured to: obtain first query information corresponding to each of the plurality of layers, based on the first sub-feature information and a pre-trained query matrix corresponding to each of the plurality of layers, wherein the first query information indicates a weight of the first sub-feature information; and obtain second query information corresponding to each of the plurality of layers, based on the second sub-feature information and the pre-trained query matrix, wherein the second query information indicates a weight of the second sub-feature information. The pre-trained query matrix may include parameters related to the first sub-feature information and the second sub-feature information.

The processor may be further configured to obtain key information corresponding to each of the plurality of layers, based on the feature information extracted from each of the plurality of layers and a pre-trained key matrix corresponding to each of the plurality of layers.

The processor may be further configured to: obtain first context information corresponding to each of the plurality of layers, the first context information indicating a correlation between the first query information and the key information; and obtain second context information corresponding to each of the plurality of layers, the second context information indicating a correlation between the second query information and the key information.

The processor may be further configured to calculate the weight for each type corresponding to each of the plurality of layers, based on the first context information and the second context information corresponding to each of the plurality of layers.

The input data of the first type and the input data of the second type may include at least one of image data, text data, sound data, or video data.

According to another aspect of the disclosure, a method of operating an electronic apparatus that performs a preset task by using a deep neural network (DNN) may include receiving input data of a first type and input data of a second type; obtaining first sub-feature information corresponding to the input data of the first type and second sub-feature information corresponding to the input data of the second type; obtaining feature information from each of a plurality of layers of the DNN by inputting the first sub-feature information and the second sub-feature information into the DNN; calculating a weight for each type corresponding to each of the plurality of layers, based on the feature information, the first sub-feature information, and the second sub-feature information; and obtaining a final output value corresponding to the preset task by applying the weight for each type, in each of the plurality of layers.

The obtaining of the first sub-feature information corresponding to the input data of the first type and the second sub-feature information corresponding to the input data of the second type may include obtaining the first sub-feature information by inputting the input data of the first type into a pre-trained first sub-network; and obtaining the second sub-feature information by inputting the input data of the second type into a pre-trained second sub-network.

The inputting of the first sub-feature information and the second sub-feature information into the DNN may include encoding the first sub-feature information and the second sub-feature information; and inputting the encoded first sub-feature information and the encoded second sub-feature information into the DNN.

The encoding of the first sub-feature information and the second sub-feature information comprises encoding the first sub-feature information and the second sub-feature information by concatenating the first sub-feature information and the second sub-feature information.

The calculating of the weight for each type corresponding to each of the plurality of layers may include obtaining first query information corresponding to each of the plurality of layers, based on the first sub-feature information and a pre-trained query matrix corresponding to each of the plurality of layers; and obtaining second query information corresponding to each of the plurality of layers, based on the second sub-feature information and the pre-trained query matrix. The first query information may indicate a weight of the first sub-feature information, and the second query information indicates a weight of the second sub-feature information, and the pre-trained query matrix may include parameters related to the first sub-feature information and the second sub-feature information.

The calculating of the weight for each type corresponding to each of the plurality of layers further may include obtaining key information corresponding to each of the plurality of layers, based on the feature information extracted from each of the plurality of layers and a pre-trained key matrix corresponding to each of the plurality of layers.

The calculating of the weight for each type corresponding to each of the plurality of layers may include obtaining first context information corresponding to each of the plurality of layers, the first context information indicating a correlation between the first query information and the key information; and obtaining second context information corresponding to each of the plurality of layers, the second context information indicating a correlation between the second query information and the key information.

The calculating of the weight for each type corresponding to each of the plurality of layers further may include calculating the weight for each type corresponding to each of the plurality of layers, based on the first context information and the second context information corresponding to each of the plurality of layers.

The input data of the first type and the input data of the second type may include at least one of image data, text data, sound data, or video data.

According to yet another aspect of the disclosure, a non-transitory computer-readable recording medium may have recorded thereon a program for executing, on a computer, the method of multi-modal data processing.

### BRIEF DESCRIPTION OF THE DRAWINGS

FIG. 1 is a diagram of an electronic apparatus that generates an output value with respect to a plurality of inputs, according to an embodiment.

FIG. 2 is a block diagram of an internal configuration of an electronic apparatus according to an embodiment.

FIG. 3A is a block diagram of an operation performed in a processor according to an embodiment.

FIG. 3B is a block diagram of detailed operations of components included in FIG. 3A.

FIG. 4 is a block diagram of an internal configuration of a weight generator according to an embodiment.

FIG. 5 is a block diagram of a detailed operation of a query information calculator according to an embodiment.

FIG. 6 is a block diagram of a detailed operation of a key information calculator according to an embodiment.

FIG. 7 is a block diagram of a detailed operation of a context information calculator according to an embodiment.

FIG. 8 is a block diagram of a detailed operation of a weight-for-each-mode calculator according to an embodiment.

FIG. 9 is a flowchart of a method of obtaining, by an electronic apparatus, a final output value by obtaining first sub-feature information, second sub-feature information, and feature-per-layer information, according to an embodiment.

FIG. 10 is a detailed flowchart of an operation of FIG. 9.

### DETAILED DESCRIPTION

Throughout the disclosure, the expression “at least one of a, b or c” indicates only a, only b, only c, both a and b, both a and c, both b and c, all of a, b, and c, or variations thereof.

The terms used in the specification are briefly described and the disclosure is described in detail.

The terms used in the disclosure have been selected from currently widely used general terms in consideration of the functions in the disclosure. However, the terms may vary according to the intention of one of ordinary skill in the art, case precedents, and the advent of new technologies. Furthermore, for special cases, meanings of the terms selected by the applicant are described in detail in the description section. Accordingly, the terms used in the disclosure are defined based on their meanings in relation to the contents discussed throughout the specification, not by their simple meanings.

When a part may “include” a certain constituent element, unless specified otherwise, it may not be construed to exclude another constituent element but may be construed to further include other constituent elements. Furthermore, terms such as “portion,” “unit,” “module,” and “block” stated in the specification may signify a unit to process at least one function or operation and the unit may be embodied by hardware, software, or a combination of hardware and software.

Embodiments are provided to further completely explain the disclosure to one of ordinary skill in the art to which the disclosure pertains. However, the disclosure is not limited thereto and it will be understood that various changes in form and details may be made therein without departing from the spirit and scope of the following claims. In the drawings, a part that is not related to a description is omitted to clearly describe the disclosure and, throughout the specification, similar parts are referenced with similar reference numerals.

Hereinafter, exemplary embodiments of the disclosure will be described in detail with reference to the accompanying drawings.

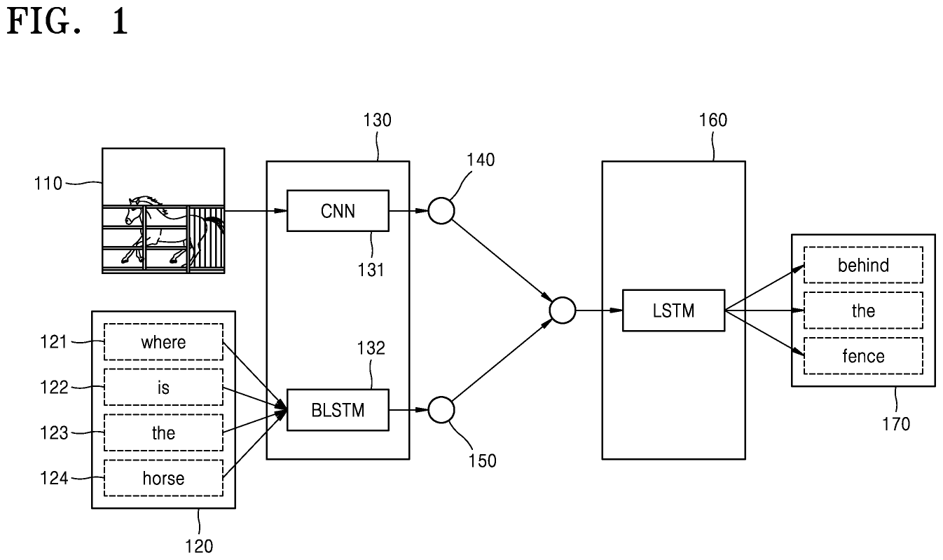

FIG. 1 illustrates an example in which an electronic apparatus that generates an output value with respect to a plurality of inputs, according to an embodiment.

A general deep learning network may perform a specific task by receiving an input of one type. For example, the general deep learning network may be a convolutional neural network (CNN) network for receiving an image as an input and processing the received image, or a long short-term memory models (LSTM) network for receiving text as an input and processing the received text. As an example, a CNN network may receive an image as an input and perform a task such as image classification.

A deep learning network according to an embodiment may receive input of various different types and perform a specific task. As such, a deep learning network that receives input of a plurality of type and processes the received input may be referred to as a multi-modal deep learning network. For example, when image data and text data are input, a multi-modal deep learning network according to an embodiment may perform a specific task based on the plurality of pieces of input data. For example, input data of a text mode may include texts that form questions related to input data of an image mode, and a multi-modal deep learning network may perform a task, for example, visual question answering (VQA), to output texts that form answers to the questions.

Referring to FIG. 1, the electronic apparatus according to an embodiment may include a sub-network 130 and a deep neural network (DNN) network 160. The sub-network 130 may receive input data of a plurality of different types and extract feature values, and may include sub-networks of different types according to the mode of each input. In this state, the input data of a plurality of different types may include, for example, data of an image mode, data of a text mode, data of a sound mode, or data of a video mode. However, the disclosure is not limited to the above-described example.

According to an embodiment, image mode data 110 may be input to a CNN sub-network 131, and first sub-feature information 140 may be extracted or obtained from the CNN sub-network 131. Furthermore, text mode data 120 may be input to a bidirectional long short-term memory (BLSTM) 132, and second sub-feature information 150 may be extracted from the BLSTM 132. The first sub-feature information 140 and the second sub-feature information 150, which are extracted, may be input to the DNN network 160, for example, an LSTM network, and an output value 170 with respect to a specific task may be obtained from the DNN network 160.

According to the illustrated example, the image mode data 110 and the text mode data 120 may be input to the sub-network 130, and the text mode data 120 may be a question related to the image mode data 110. For example, the text mode data 120 may include a plurality of words 121, 122, 123, and 124 forming a question related to question related to the image mode data 110.

The sub-network 130 may extract the first sub-feature information 140 and the second sub-feature information 150 based on the input information.

For example, the first sub-feature information 140 may include feature information related to an image, and as an example, may include information that distinguishes a particular object and background in an image. Furthermore, the second sub-feature information 150 may include feature information related to a plurality of words forming a question, and as an example, information for distinguishing an interrogative 121 and an object 124 in the words forming a question.

The first sub-feature information 140 and the second sub-feature information 150, which are extracted, may be input to the DNN network 160, for example, an LSTM network, and the output value 170, for example, an answer to the question, with respect to a specific task may be obtained from the DNN network 160.

The electronic apparatus according to an embodiment may receive input of various different types, extract features for each type needed for performing a specific task, and fuse the extracted features for each type, thereby performing learning or training for a task. In this state, input data of different types may have different importance in performing a task. For example, in the performing of s specific task, image input data may be more important than text input data. Accordingly, in the multi-modal deep learning network, when a specific task is performed by reflecting a weight for each type indicating importance related to a plurality of variable multi-modal inputs, performance of the multi-modal deep learning network may be improved.

The electronic apparatus according to an embodiment may perform a specific task, based on the weight for each type with respect to input data of different types, which is described below in detail with reference to the accompanying drawings.

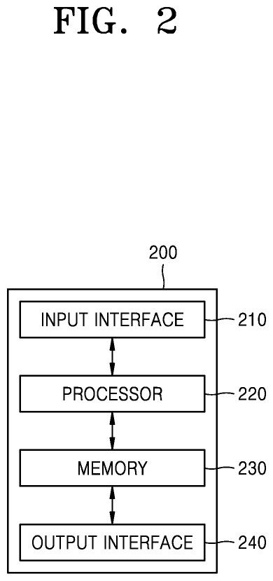

FIG. 2 is a block diagram of an internal configuration of an electronic apparatus 200 according to an embodiment.

Referring to FIG. 2, the electronic apparatus 200 according to an embodiment may include an input interface 210, a processor 220, a memory 230, and an output interface 240.

According to an embodiment, the input interface 210 may mean a device for inputting data for a user to control the electronic apparatus 200. For example, the input interface 210 may include a camera, a microphone, a key pad, a dome switch, a touch pad according to a contact capacitive method, a pressure resistance film method, an infrared sensing method, a surface ultrasound conduction method, an integral tension measurement method, a piezo effect method, and the like, a jog wheel, a jog switch, and the like, but the disclosure is not limited thereto.

According to an embodiment, the input interface 210 may receive a user input that is needed for the electronic apparatus 200 to perform a specific task. According to an embodiment, when a user input includes image data and sound data, the input interface 210 may receive each of an image data input and a sound data input of a user through a camera and a microphone. The input interface 210, without being limited to the above-described example, may receive various types of a user input through various devices.

The output interface 240 may output an audio signal, a video signal, or a vibration signal, and the output interface 240 may include at least one of a display, a sound outputter, or a vibration motor. According to an embodiment, the output interface 240 may output an output value of the performing of a specific task according to an input data. For example, when input data is image data and data, for example, text data or sound data, which includes a question related to the image data, an answer to the question may be displayed as text through a display or as sound through a sound outputter.

The processor 220 according to an embodiment may control an overall operation of the electronic apparatus 200. Furthermore, the processor 220 may control other components included in the electronic apparatus 200 to perform a certain operation.

The processor 220 according to an embodiment may perform one or more programs stored in the memory 230. The processor 220 may include a single core, a dual core, a triple core, a quad core, and a multiple core thereof. Furthermore, the processor 220 may include a plurality of processors.

The processor 220 according to an embodiment may include an artificial intelligence dedicated processor that is designed to have a hardware structure specialized for processing a neural network model. The processor 220 may generate a neural network model, train a neural network model, perform an operation based on input data received by using a neural network model, and generate output data. A neural network model may include various types of neural network models, for example, CNN, DNN, a recurrent neural network (RNN), a restricted Boltzmann machine (RBM), a deep belief network (DBN, LSTM, BLSTM), a bidirectional recurrent DNN (BRDNN), a deep Q-network, and the like, but the disclosure is not limited thereto.

The processor 220 according to an embodiment may calculate importance of input of different types, and output a final output value corresponding to a preset task by applying a weight for each type reflecting the calculated importance. The processor 220 according to an embodiment may receive an input of pieces of input data of different types and extract sub-feature information about each piece of input data. The processor 220 according to an embodiment may encode the extracted sub-feature information and transmit the extracted sub-feature information to a DNN network.

The processor 220 according to an embodiment may obtain feature information extracted from each of the layers of the DNN network. The processor 220 according to an embodiment may calculate a weight for each type by using the extracted sub-feature information and feature information extracted from the DNN network. The processor 220 according to an embodiment may output a final output value corresponding to a preset task by applying the calculated weight for each type to the DNN network.

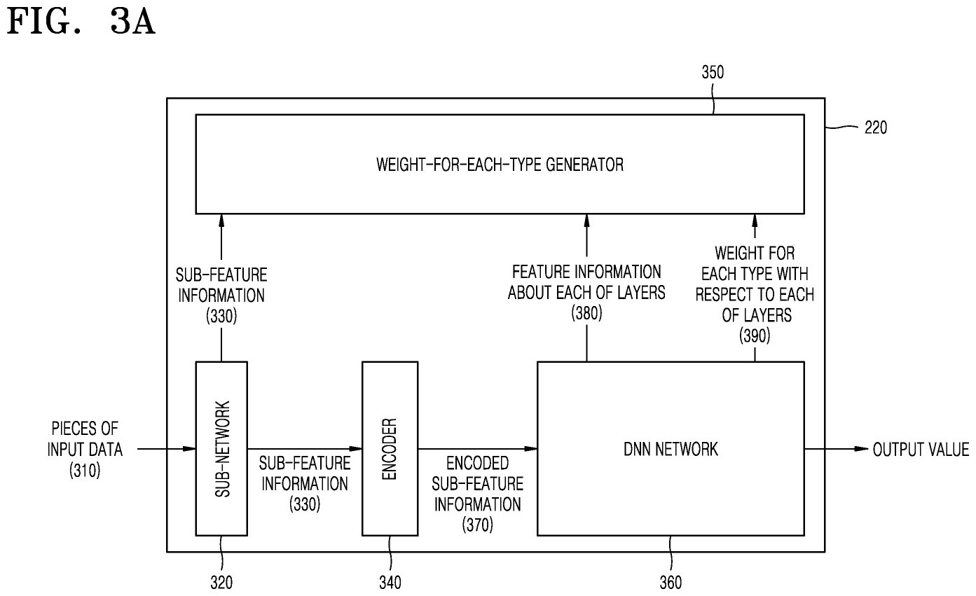

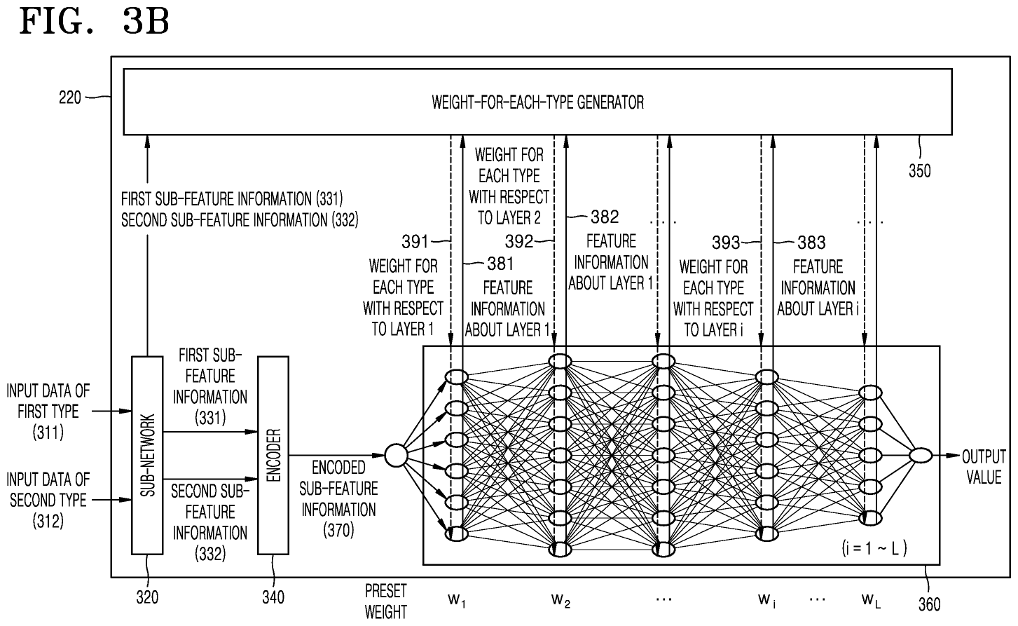

The operation of the processor 220 according to an embodiment may be described below in detail with reference to FIGS. 3A to 8.

According to an embodiment, the memory 230 may store various data, programs, or applications to drive and control the electronic apparatus 200.

Furthermore, the program stored in the memory 230 may include one or more instructions. The programs (one or more instructions) or applications stored in the memory 230 may be executed by the processor 220.

The memory 230 may include at least one type of storage media such as a flash memory type, a hard disk type, a multimedia card micro type, a card type memory, for example, an SD or XD memory and the like, random access memory (RAM), static RAM (SRAM), read-only memory (ROM), electrically erasable programmable ROM (EEPROM), programmable ROM (PROM), a magnetic memory, a magnetic disc, and an optical disc.

FIG. 3A is a block diagram of an operation performed by the processor 220 according to an embodiment.

Referring to FIG. 3A, the electronic apparatus 200 according to an embodiment may generate a weight for each type reflecting importance for each type with respect to input data of different types. The electronic apparatus 200 according to an embodiment may include a sub-network 320, an encoder 340, a weight-for-each-type generator 350, and a DNN network 360.

The sub-network 320 may receive a plurality of pieces of input data 310 and extract sub-feature information 330 about each of the input data 310. In this state, the input data 310 may include input data of different types, and the sub-network 320 may include sub-networks of different types according to the type of each of the input data 310. For example, when the input data 310 include image data and text data, the sub-network 320 may include a CNN network and a BLSTM network.

In the following description, for convenience of explanation, according to an embodiment, it is assumed that the input data 310 include image data V and sound data S. However, the disclosure is not limited thereto, and the input data 310 may include image data, text data, sound data, and the like.

The sub-feature information 330 that is feature information about the input data 310 extracted from the sub-network 320 may be transmitted, or input, to the encoder 340 and the weight-for-each-type generator 350. According to the above-described example, the sub-feature information about the image data V and the sub-feature information about the sound data S may be transmitted, or input, to the encoder 340 and the weight-for-each-type generator 350. Furthermore, according to an embodiment, type identification information for identifying the type of the input data 310, with the sub-feature information 330, may be transmitted, or input, to the encoder 340 and the weight-for-each-type generator 350.

The encoder 340 may encode the sub-feature information 330 based on the type identification information by which the type of input data transmitted from the sub-network 320 may be distinguished. For example, the encoder 340 may encode the sub-feature information 330 by concatenating the sub-feature information 330 based on the type identification information. The encoder 340 may transmit encoded sub-feature information 370 to the DNN network 360.

The DNN network 360 may include a plurality of layers. The DNN network 360 may receive an input of the encoded sub-feature information 370 and extract feature information 380 from each of the layers, and the feature information 380 that is extracted may be transmitted to the weight-for-each-type generator 350.

The weight-for-each-type generator 350 may calculate a weight 390 for each type with respect to each of the layers, based on the sub-feature information 330 received from the sub-network 320 and the feature information 380 extracted from each of the layers. In this state, the weight 390 for each type calculated in the weight-for-each-type generator 350 may be a value that is multiplied to a preset weight value with respect to each layer, by reflecting the importance for each type with respect to data of different types. As such, a more accurate output value may be obtained by reflecting the importance for each type with respect to a specific task performed in the electronic apparatus.

For example, when image data and sound data are received as an input, sub-feature information about an image type, sub-feature information about a sound type, and the feature information extracted from each of the layers of the DNN network 360 may be input to the weight-for-each-type generator 350. The weight-for-each-type generator 350 may calculate the weight 390 for each type based on the input sub-feature information about an image type, sub-feature information about a sound type, and feature information extracted from each of the layers. When input data according to an embodiment includes input data of different types, the weight 390 for each type may be a value indicating importance of each piece of input data. The weight-for-each-type generator 350 may calculate a weight for each type corresponding to each of a plurality of layers.

The DNN network 360 may obtain a final output value corresponding to a preset task by applying the weight 390 for each type calculated in the weight-for-each-type generator 350 in each of the layers. For example, the DNN network 360 may obtain a final output value corresponding to a preset task by multiplying a preset weight value with respect to a plurality of layer of the network by the weight 390 for each type calculated in the weight-for-each-type generator 350.

FIG. 3B is a block diagram of detailed operations of components included FIG. 3A.

Referring to FIG. 3B, the electronic apparatus 200 according to an embodiment may generate a weight for each type reflecting the importance for each type with respect to input data 311 of a first type and input data 312 of a second type, which are input. However, the type of input data is not limited to the above description, and may include 3 or more types.

The electronic apparatus 200 according to an embodiment may include the sub-network 320, the encoder 340, the weight-for-each-type generator 350, and the DNN network 360.

The sub-network 320 may extract first sub-feature information 331 by receiving an input of the input data 311 of a first type, and second sub-feature information 332 by receiving an input of the input data 312 of a second type. The first sub-feature information 331 and the second sub-feature information 332, which are extracted from the sub-network 320, may be transmitted, or input, to the encoder 340 and the weight-for-each-type generator 350. Furthermore, according to an embodiment, the type identification information for distinguishing the type of the input data 311 of a first type and the input data 312 of a second type, with the first sub-feature information 331 and the second sub-feature information 332, may be transmitted, or input, to the encoder 340 and the weight-for-each-type generator 350.

The encoder 340 may encode and transmit the first sub-feature information 331 and the second sub-feature information 332 to the DNN network 360, based on the type identification information for distinguishing the type of the input data 311 of a first type and the input data 312 of a second type, which are transmitted from the sub-network 320.

The DNN network 360 may include a plurality of layers. For example, the DNN network 360 may include i layers (i=1 to L). The DNN network 360 may extract the feature information 380 from each of the layers by receiving the encoded sub-feature information 370. For example, feature information 381 about a first layer may be extracted from the first layer, feature information 382 about a second layer may be extracted from the second layer, and likewise, feature information 383 about the i-th layer may be extracted from the i-th layer. The feature information 380 that is extracted may be transmitted to the weight-for-each-type generator 350.

The feature information 380 may be a value obtained by multiplying an input to each of the i layers (i=1 to L) of the DNN network (360) by a preset weight value wᵢ of the layer.

The weight-for-each-type generator 350 may calculate the weight 390 for each type with respect to each of the layers based on the first sub-feature information 331 and the second sub-feature information 332 received from the sub-network 320 and the feature information 380 extracted from each of the layers. For example, a weight 391 for each type corresponding to a first layer may be calculated, a weight 392 for each type corresponding to a second layer may be calculated, and likewise, a weight 393 for each type corresponding to the i-th layer may be calculated.

In this state, the weight 390 for each type calculated in the weight-for-each-type generator 350 may be a value reflecting the importance for each type with respect to the input data 311 of a first type and the input data 312 of a second type.

The DNN network 360 may obtain a final output value corresponding to a preset task by applying the weight 390 for each type in each of the layers. For example, the DNN network 360 may obtain a final output value corresponding to a preset task by multiplying the preset weight value (i=1 to L) of the i-th layer (i=1 to L) of the network by the weight 393 for each type with respect to the i-th layer that is received from the weight-for-each-type generator 350.

As such, a more accurate output value may be obtained by considering the importance for each type with respect to a specific task performed in the electronic apparatus 200.

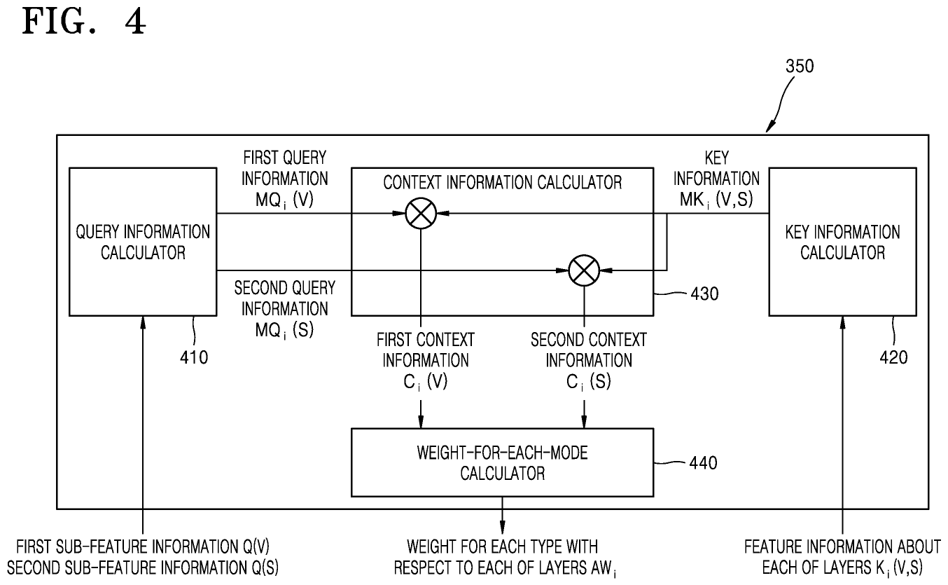

FIG. 4 is a block diagram of the internal configuration of the weight-for-each-type generator 350 according to an embodiment.

Referring to FIG. 4, the weight-for-each-type generator 350 according to an embodiment may include a query information calculator 410, a key information calculator 420, a context information calculator 430, and a weight-for-each-type calculator 440.

The query information calculator 410 according to an embodiment may calculate query-for-each-type information indicating new feature information of sub-feature-for-each-type information.

The query information calculator 410 according to an embodiment may receive, as an input, first sub-feature information Q(V) and second sub-feature information Q(S). In this state, for example, the first sub-feature information Q(V) may be sub-feature information about image input data V, and the second sub-feature information Q(S) may be sub-feature information about sound input data S. However, the input data is not limited thereto, and may include image input data, text input data, sound input data, video input data, and the like.

The query information calculator 410 according to an embodiment may calculate first query information MQᵢ(V) by receiving the first sub-feature information Q(V), and the second query information MQᵢ(V) by receiving the first sub-feature information information Q(S). The query information calculator 410 may calculate the first query information MQᵢ(V) by using the first sub-feature information Q(V) and a pre-trained query matrix WQᵢ(V,S) corresponding to the i-th layer of the DNN network 360, and the second query information MQᵢ(V,S) using the second sub-feature information Q(S) and the pre-trained query matrix WQᵢ(V,S) corresponding to the i-th layer. The first query information MQᵢ(V) and the second query information MQᵢ(S) may indicate query information corresponding to the i-th layer of the DNN network.

In this state, the first query information MQᵢ(V) may indicate the characteristics of the first sub-feature information Q(V) about the first sub-feature information Q(V) and the second sub-feature information Q(S), and the second query information MQᵢ(S) may indicate the characteristics of the second sub-feature information Q(S) about the first sub-feature information Q(V) and the second sub-feature information Q(S).

For example, when the input data is the image input data V and the sound input data S, the first query information MQᵢV) may indicate the characteristics of the first sub-feature information Q(V) of an image type with respect to the first sub-feature information Q(V) of an image type and the second sub-feature information Q(S) of a sound type.

Furthermore, the second query information MQᵢ(S) may indicate the characteristics of the second sub-feature information Q(S) about the first sub-feature information Q(V) of an image type and the second sub-feature information Q(S) of a sound type.

The key information calculator 420 according to an embodiment may calculate key information based on the feature information extracted from each of the layers of the DNN network.

The key information calculator 420 according to an embodiment may receive, as an input, feature information Kᵢ(V,S) extracted from each of the layers of the DNN network. In this state, the characteristics of an image type and a sound type may be mixed in the feature information Kᵢ(V,S) extracted from each of the layers.

The key information calculator 420 according to an embodiment may calculate key information MKᵢ(V,S) by receiving, as an input, the feature information Kᵢ(V,S) extracted from each of the layers. The key information calculator 420 may calculate the key information MKᵢ(V,S) corresponding to the i-th layer of the DNN network, by using the feature information Kᵢ(V,S) extracted from the i-th layer of the DNN network and pre-trained key matrix W^{K}ᵢ(V,S) corresponding to the i-th layer of the DNN network.

In this state, the key information MKᵢ(V,S) may be a value reflecting relative importance of an image type and a sound type in the feature information Kᵢ (V,S) extracted from the i-th layer of the DNN network.

The context information calculator 430 according to an embodiment may calculate context information that is a value indicating a correlation between query information and key information.

The context calculator 430 according to an embodiment may receive, as an input, the first query information MQᵢ(V) and the second query information MQᵢ(S) calculated by the query information calculator 410, and the key information MKᵢ(V,S) calculated by the key information calculator 420. In this state, the first query information MQᵢ(V), the second query information MQᵢ(S), and the key information MKᵢ(V,S) may be values corresponding to the i-th layer of the layers of the DNN network.

The context calculator 430 according to an embodiment may calculate first context information Cᵢ(V) by using the first query information MQᵢ(V) and the key information MKᵢ(V,S), and second context information Cᵢ(S) by using the second query information MQᵢ(S) and the key information MKᵢ(V,S). The first context information Cᵢ(V) and the second context information Cᵢ(S) may be values corresponding to the i-th layer of the layers of the DNN network.

In this state, the first context information Cᵢ(V) may be a value indicating a correlation between the first query information MQᵢ(V) indicating relative importance of an image type V in the i-th layer of the DNN network and the key information MKᵢ(V,S) reflecting relative importance of the image type V and a sound type S in the i-th layer of the DNN network.

Furthermore, the second context information Cᵢ(S) may be a value indicating a correlation between the second query information MQᵢ(S) indicating relative importance of the sound type S in the i-th layer of the DNN network and the key information MKᵢ(V,S) reflecting relative importance of the image type V and the sound type S in the i-th layer of the DNN network.

The weight-for-each-type calculator 440 according to an embodiment may calculate a weight for each type that can assign a weight to input data of an important type of the input data of a plurality of types.

The weight-for-each-type calculator 440 according to an embodiment may calculate a weight AWᵢ for each type by using the first context information Cᵢ(V) and the second context information Cᵢ(S). The weight AWᵢ for each type may be a value corresponding to the i-th layer of the layers of the DNN network.

The weight-for-each-type calculator 440 according to an embodiment may calculate one weight AWᵢ for each type with respect to the layers of the DNN network. In this case, one weight AWᵢ for each type may be calculated by using the maximum value of the first context information Cᵢ(V) and the second context information Cᵢ(S).

According to another embodiment, the weight-for-each-type calculator 440 may calculate the weights AWᵢ(V) and AWᵢ(S) for each type with respect to the layers of the DNN network. In this case, the weight AWᵢ(V) for each type with respect to the image type that is a first type may be calculated by using the first context information Cᵢ(V), and the weight AWᵢ(S) for each type with respect to the sound type that is a second type may be calculated by using the second context information Cᵢ(S).

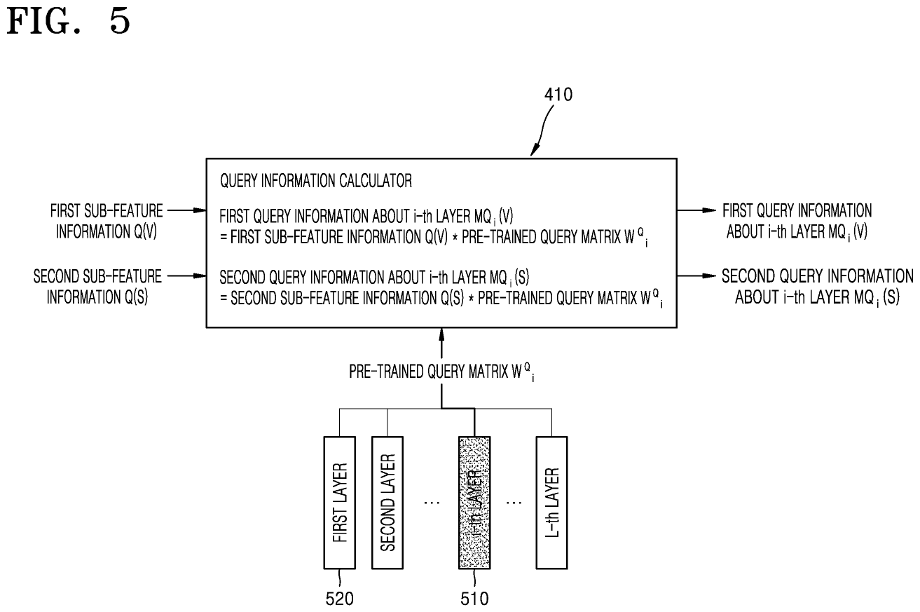

FIG. 5 is a block diagram of a detailed operation of a query information calculator according to an embodiment.

Referring to FIG. 5, the query information calculator 410 may calculate the first query information MQᵢ(V) by using the first sub-feature information Q(V) and the pre-trained query matrix WQᵢ(V,S) and the second query information MQᵢ(S) by using the second sub-feature information Q(S) and the pre-trained query matrix W^{Q}ᵢ(V,S)_{.}

In this state, the pre-trained query matrix WQᵢ(V,S), the first query information MQᵢ(V), and the second query information MQᵢ(S) may be values corresponding to an i-th layer 510 of the layers of the DNN network.

The first query information MQᵢ(V) and the second query information MQᵢ(S) may be calculated by Equation 1 below.

MQᵢ(V)=Q(V)^{T}WQᵢ(V,S)MQᵢ(S)=Q(S)^{T}WQᵢ(V,S) [Equation 1]

In Equation 1, Q(V) denotes first sub-feature information, Q(S) denotes second sub-feature information, MQᵢ(V) denotes first query information, MQᵢ(S) denotes second query information, and WQᵢ(V,S) denotes a pre-trained query matrix.

The pre-trained query matrix WQᵢ(V,S) according to an embodiment may be a value for performing an inner product with the first sub-feature information Q(V) to indicate relative importance of the first sub-feature information Q(V) to the second sub-feature information Q(S), in the i-th layer 510 of the layers of the DNN network.

Furthermore, likewise, the pre-trained query matrix WQᵢ(V,S) according to an embodiment may be a value for performing an inner product with the second sub-feature information Q(S) to indicate relative importance of the second sub-feature information Q(S) to the first sub-feature information Q(V), in the i-th layer 510 of the layers of the DNN network.

The pre-trained query matrix WQᵢ(V,S) according to an embodiment may be a matrix including parameters related to the first sub-feature information Q(V) and the second sub-feature information Q(S), and also a value pre-trained to correspond to the i-th layer of the layers of the DNN network.

The electronic apparatus 200 according to an embodiment may calculate a weight for each type reflecting importance with respect to inputs of various different types, for example, V and S, to output an accurate output value. In this state, a query matrix used for the calculation of a weight for each type may be trained to have an optimal value, and a query matrix that is completely trained to have an optimal value may be defined as the pre-trained query matrix WQᵢ(V,S).

As illustrated in FIG. 5, the query information calculator 410 may calculate first query information and second query information corresponding to each of the layers of the DNN network, by using the pre-trained query matrix corresponding to each of the layers of the DNN network.

For example, the query information calculator 410 may calculate the first query information MQ₁(V) about a first layer 520 of the DNN network, by performing an inner product of the first sub-feature information Q(V) and the pre-trained query matrix W^{Q}₁(V,S) defined in the first layer 520 of the DNN network. Furthermore, the query information calculator 410 may calculate the second query information MQ₁(S) about the first layer 520 of the DNN network, by performing an inner product of the second sub-feature information Q(S) and the pre-trained query matrix W^{Q}₁(V,S) defined in the first layer 520 of the DNN network.

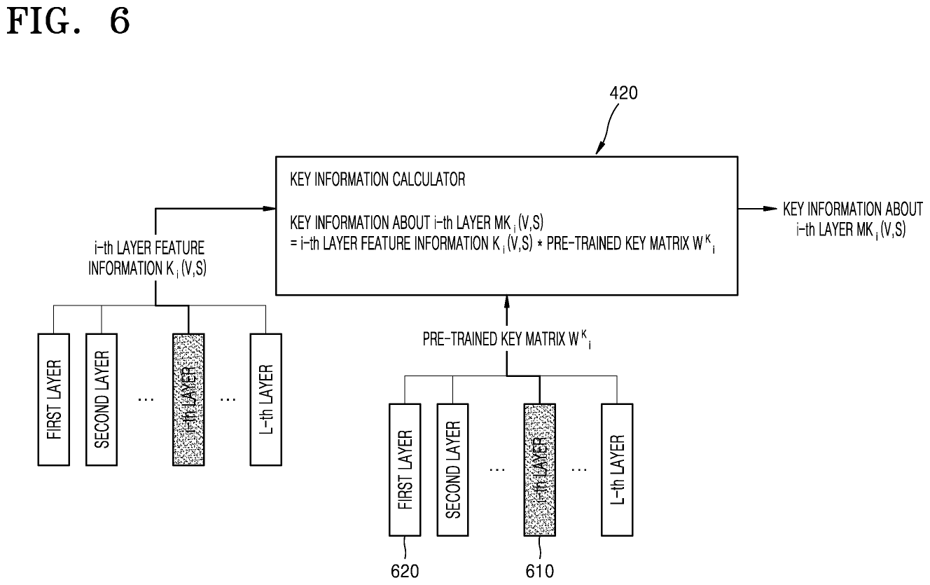

FIG. 6 is a block diagram of a detailed operation of the key information calculator 420 according to an embodiment.

Referring to FIG. 6, the key information calculator 420 may calculate the key information MKᵢ(V,S) by using the feature information Kᵢ(V,S) and a pre-trained key matrix W^{K}ᵢ(V,S).

In this state, the feature information Kᵢ(V,S), the pre-trained key matrix W^{K}ᵢ(V,S), and the key information MKᵢ(V,S) may be values correspond to an i-th layer 610 of the layers of the DNN network.

The key information MKᵢ(V,S) may be calculated by Equation 2 below.

MKᵢ(V,S)=Kᵢ(V,S)^{T}W^{K}ᵢ(V,S) [Equation 2]

In Equation 2, Kᵢ(V,S) denotes feature information, MKᵢ(V,S) denotes key information, and W^{K}ᵢ(V,S) denotes a pre-trained key matrix.

The pre-trained key matrix W^{K}ᵢ(V,S) according to an embodiment may be a value for performing an inner product with the feature information Kᵢ(V,S) indicate relative importance of the image type V and the sound type S, in the feature information Kᵢ(V,S) extracted from the i-th layer of the layers of the DNN network.

The pre-trained key matrix W^{K}ᵢ(V,S) according to an embodiment may be a matrix including parameters related to the image type V and the sound type S, and also a value pre-trained to correspond to the i-th layer of the layers of the DNN network.

The electronic apparatus 200 according to an embodiment may calculate a weight for each type well reflecting importance with respect to inputs of various different types, for example, V and S, to output an accurate output value. In this state, a key matrix used for the calculation of a weight for each type may be trained to have an optimal value, and a key matrix that is completely trained to have an optimal value may be defined as the pre-trained key matrix W^{K}ᵢ(V,S).

As illustrated in FIG. 6, the key information calculator 420 may calculate key information corresponding to each of the layers of the DNN network, by using the pre-trained key matrix corresponding to each of the layers of the DNN network.

For example, the key information calculator 420 may calculate the key information MK₁(V,S) about a first layer 620 of DNN network, by performing an inner product of the feature information K₁ (V,S) extracted from the first layer 620 of DNN network and the pre-trained key matrix W^{K}₁(V,S) defined in the first layer 620 of DNN network.

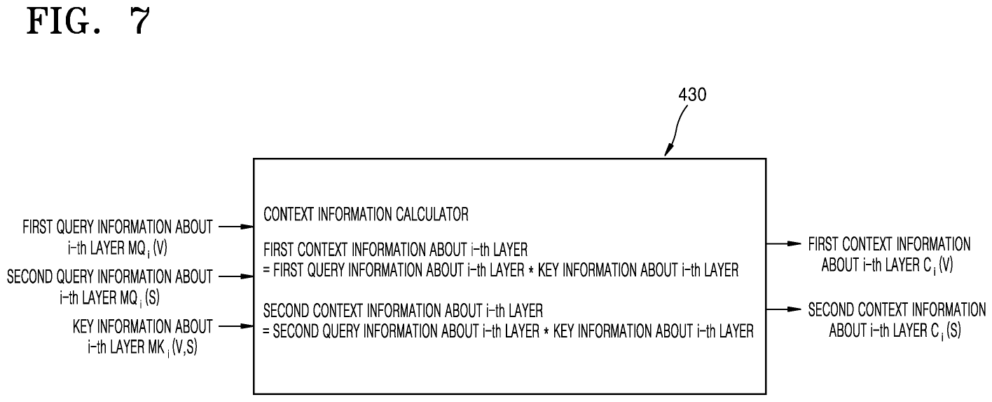

FIG. 7 is a block diagram of a detailed operation of the context information calculator 430 according to an embodiment.

Referring to FIG. 7, the context information calculator 430 may calculate the first context information Cᵢ(V) by using the first query information MQᵢ(V) and the key information MKᵢ(V,S), and the second context information Cᵢ(S) by using the second query information MQᵢ(S) and the key information MKᵢ(V,S).

In this state, the first query information MQᵢ(V), the second query information MQᵢ(S), the first context information Cᵢ(V), the second context information Cᵢ(S), and the key information MKᵢ(V,S) may be values corresponding to the i-th layer of the layers of the DNN network.

The first context information Cᵢ(V) and the second context information Cᵢ(S) may be calculated by Equation 3 below.

Cᵢ(V)=MQᵢ(V)^{T}MKᵢ(V,S)Cᵢ(S)=MQᵢ(S)^{T}MKᵢ(V,S) [Equation 3]

In Equation 3, MQᵢ(V) denotes first query information, MQᵢ(S) denotes second query information, MKᵢ(V,S) denotes key information, Cᵢ(V) denotes first context information, and Cᵢ(S) denotes second context information.

In an embodiment, when an inner product is performed between the first query information MQᵢ(V) indicating the relative importance of the image type V and the key information MKᵢ(V,S) reflecting the relative importance of the image type V and the sound type S, the first context information Cᵢ(V) that is a value indicating a correlation between the first query information MQᵢ(V) and the key information MKᵢ(V,S) may be calculated.

Furthermore, in an embodiment, when an inner product is performed between the second query information MQᵢ(s) indicating the relative importance of the sound type S and the key information MKᵢ(V,S) reflecting the relative importance of the image type V and the sound type S, the second context information Cᵢ(S) that is a value indicating a correlation between the second query information MQᵢ(S) and the key information MKᵢ(V,S) may be calculated.

In this state, for example, when the first context information Cᵢ(V) is greater than the second context information Cᵢ(S), it may be determined that the correlation between the first query information MQᵢ(V) and the key information MKᵢ(V,S) is much great, and the relative importance of the first type V is greater than that of the second type S.

As illustrated in FIG. 7, the context information calculator 430 may calculate the first context information Cᵢ(V) and the second context information Cᵢ(S) corresponding to each of the layers of the DNN network, by using the first query information MQ₁(V), the second query information MQ₁(S), and the key information MK₁(V,S) corresponding to each of the layers of the DNN network.

For example, the context information calculator 430 may calculate the first context information C₁(V) about the first layer of the DNN network by performing an inner product of the first query information MQ₁(V) about the first layer of the DNN network and the key information MK₁(V,S) about the first layer of the DNN network. Furthermore, the context information calculator 430 may calculate the second context information C₁(S) about the first layer of the DNN network, by performing an inner product of the second query information MQ₁(S) about the first layer of the DNN network and the key information MK₁(V,S) about the first layer of the DNN network.

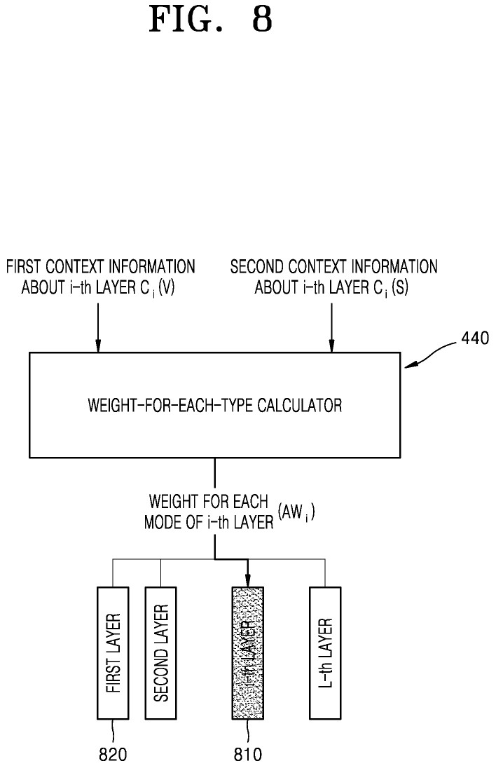

FIG. 8 is a block diagram of a detailed operation of the weight-for-each-type calculator 440 according to an embodiment.

Referring to FIG. 8, the weight-for-each-type calculator 440 may calculate the weight AWᵢ for each type by using the first context information Cᵢ(V) and the second context information Cᵢ(S).

In this state, the first context information Cᵢ(V), the second context information Cᵢ(S), and the weight AWᵢ I for each type may be values corresponding to the i-th layer 810 of the layers of the DNN network.

The weight-for-each-type calculator 440 according to an embodiment may calculate one weight AWᵢ for each type with respect to the i-th layer of the layers of the DNN network, and the weight AWᵢ for each type may be calculated by Equation 4 below.

$${AW}_{i} = \frac{Max ( {C}_{i} ( V ) , {C}_{i} ( S ) )}{{\sum }_{I = V}^{s} {C}_{i} ( I )} \qquad [ Equation 4 ]$$

In Equation 4, Cᵢ(V) denotes first context information, Cᵢ(S) denotes second context information, and AWᵢ denotes a weight for each type

According to an embodiment, a normalized maximum value of context information about the i-th layer of a plurality of layers may be used as the weight AWᵢ for each type. The weight-for-each-type calculator 440 may calculate the weight AWᵢ for each type for normalization of context information, by dividing the maximum value of the first context information Cᵢ(V) and the second context information Cᵢ(S) by a sum of the first context information Cᵢ(V) and the second context information Cᵢ(S)

According to an embodiment, the calculated weight AWᵢ for each type may be a value that can assign a weight to input data of an important type of the input data having a plurality of types. The electronic apparatus 200 according to an embodiment may obtain a final output value corresponding to a preset task by multiplying the calculated weight AWᵢ for each type to the preset weight value wᵢ of the DNN network.

The weight-for-each-type calculator 440 according to another embodiment may calculate the weights AWᵢ(V) and AWᵢ(S) for each type with respect to the i-th layer of the layers of the DNN network, and the weights AWᵢ(V) and AWᵢ(S) for each type may be calculated by Equation 5 below.

$${AW}_{i} ( V ) = \frac{{C}_{i} ( V )}{{\sum }_{I = V}^{s} {C}_{i} ( I )} {AW}_{i} ( S ) = \frac{{C}_{i} ( S )}{{\sum }_{I = V}^{s} {C}_{i} ( I )} \qquad [ Equation 5 ]$$

In Equation 5, Cᵢ(V) denotes first context information, Cᵢ(S) denotes second context information, AWᵢ(V) denotes a first weight for each type, and AWᵢ(S) denotes a second weight for each type.

According to another embodiment, the weight-for-each-type calculator 440 may use a normalized value of context information about the i-th layer of a plurality of layers as a weight for each type. The weight-for-each-type calculator 440 may calculate the first weight AWᵢ(V) for each type for normalization of context information, by dividing the first context information Cᵢ(V) by a sum of the first context information Cᵢ(V) and the second context information Cᵢ(S), and the second weight AWᵢ(S) for each type by dividing the second context information Cᵢ(S) by a sum of the first context information Cᵢ(V) and the second context information Cᵢ(S).

According to another embodiment, the first weight AWᵢ(V) for each type and the second weight AWᵢ(S) for each type that are calculated may be values that can assign a weight to input data of an important type of the input data having a plurality of input types. The electronic apparatus 200 according to an embodiment may obtain a final output value corresponding to a preset task by multiplying the calculated weights AWᵢ(V) and AWᵢ(S) for each type by the preset weight wᵢ value of the DNN network.

As illustrated in FIG. 8, the weight-for-each-type calculator 440 may calculate a weight for each type corresponding to each of the layers of the DNN network, by using the first context information Cᵢ(V) and the second context information Cᵢ(S) corresponding to each of the layers of the DNN network.

For example, the weight-for-each-type calculator 440 may calculate the weights AW₁ or AW₁(V) and AW₁(S) for each type with respect to the first layer 820 of the DNN network, by using the first context information C₁(V) about the first layer 820 of the DNN network and the second context information C₁(S) about the first layer 820 of the DNN network.

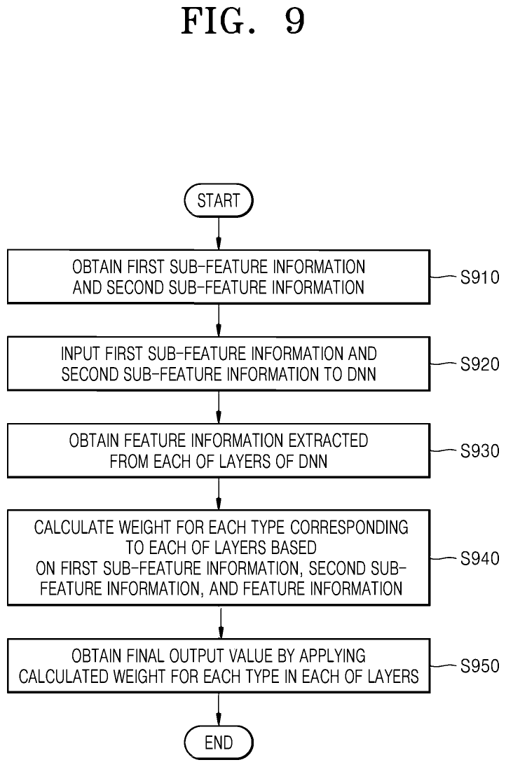

FIG. 9 is a flowchart of a method of obtaining, by the electronic apparatus 200, a final output value by obtaining first sub-feature information, second sub-feature information, and feature-per-layer information, according to an embodiment.

In operation S910, the electronic apparatus 200 may obtain first sub-feature information Q(V) and second sub-feature information Q(S).

According to an embodiment, the first sub-feature information Q(V) may be information that is extracted by a sub-network by receiving input data of the first type V. According to an embodiment, the second sub-feature information Q(S) may be information that is extracted by a sub-network by receiving input data of the second type S.

Although a case in which the first type is the image type V and the second type is the sound type S is described above as an example, the disclosure is not limited thereto. Furthermore, a case in which the input data is input in two types is described above as an example, the disclosure is not limited thereto, and there are two or more types, that is, a plurality of types.

In operation S920, the electronic apparatus 200 may input the obtained first sub-feature information Q(V) and second sub-feature information Q(S) to the DNN network.

According to an embodiment, the obtained first sub-feature information Q(V) and second sub-feature information Q(S) may be transmitted, or input, to the encoder. Furthermore, according to an embodiment, type identification information for distinguishing the type of input data, with the sub-feature information, may be transmitted, or input, to the encoder.

According to an embodiment, the encoder may encode the first sub-feature information Q(V) and the second sub-feature information Q(S) based on the received type identification information, and transmit the encoded information to the DNN network. For example, the encoder may encode the first sub-feature information Q(V) and the second sub-feature information Q(S) by concatenating the information based on the type identification information, and transmit the encoded information to the DNN network.

In operation S930, the electronic apparatus 200 may obtain feature information extracted from each of the layers of the DNN network.

According to an embodiment, the DNN network 360 may receive the encoded first sub-feature information Q(V) and second sub-feature information Q(S) and extract the feature information 370 from each of the layers. The feature information 370 may be a value obtained by multiplying an input to each of the layers of the DNN network 360 by the preset weight value wᵢ of the layer.

For example, when the DNN network 360 includes a plurality of layers, the first layer may receive the encoded first sub-feature information Q(V) and second sub-feature information Q(S). The feature information K₁(V,S) about the first layer may be a value obtained by multiplying the encoded first sub-feature information Q(V) and second sub-feature information Q(S) input to the first layer by the preset weight value w₁ of the first layer.

The second layer may receive the feature information K₁(V,S) about the first layer. The feature information K₂(V,S) about the second layer may be a value obtained by multiplying the feature information K₁ (V,S) about the first layer input to the second layer by a preset weight value w₂ of the second layer.

Likewise, the feature information Kᵢ(V,S) about the i-th layer of the layers of the DNN network 360 may be a value obtained by multiplying the feature information Kᵢ₊₁ (V,S) about the (i−1)th layer input to the i-th layer by a preset weight value wᵢ of the i-th layer.

In operation S940, the electronic apparatus 200 may calculate a weight for each type corresponding to each of the layers, based on the obtained first sub-feature information Q(V), second sub-feature information Q(S), and feature information Kᵢ(V,S)

In an embodiment, the weight AWᵢ for each type corresponding to each of the layers may be calculated by the weight-for-each-type generator 350. The weight-for-each-type generator 350 may calculate the weight AWᵢ for each type with respect to each of the layers, based on the first sub-feature information Q(V) and the second sub-feature information Kᵢ(V,S), which are obtained from the sub-network, and the feature information Kᵢ(V,S) extracted from each of the layers.

In this state, the weight AWᵢ for each type calculated by the weight-for-each-type generator 350 may be a value reflecting relative importance with respect to the first type V and the second type S, and may be a value corresponding to each of the layers of the DNN network 360.

In operation S950, the electronic apparatus 200 may obtain a final output value corresponding to a preset task by applying the calculated weight AWᵢ for each type in each of the layers of the DNN network 360.

In an embodiment, the DNN network 360 may obtain a final output value corresponding to a preset task, by applying the weight AWᵢ for each type calculated by the weight-for-each-type generator 350 to each of the layers.

For example, the DNN network 360 may obtain a final output value corresponding to a preset task by multiplying the preset weight value wᵢ with respect to the i-th layer of a plurality of layers of a network by the weight AWᵢ for each type with respect to the i-th layer.

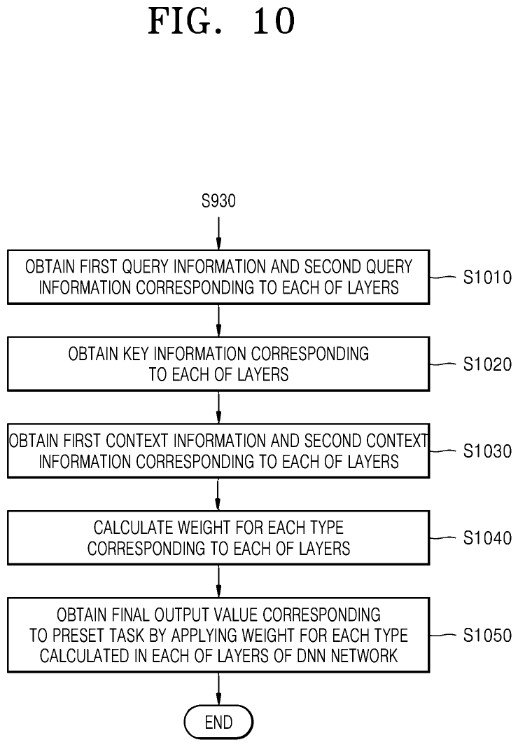

FIG. 10 is a detailed flowchart of the operation of FIG. 9.

Referring to FIG. 10, S1010 may be performed after the operation S930 of FIG. 9.

In operation S1010, the electronic apparatus 200 may obtain first query information and second query information corresponding to each of the layers of the DNN network.

In an embodiment, the first query information MQᵢ(V) and the second query information MQᵢ(S) may be calculated by the query information calculator 410.

In an embodiment, the query information calculator 410 may calculate the first query information MQᵢ(V) by using the first sub-feature information Q(V) and the pre-trained query matrix WQᵢ (V,S). Likewise, in an embodiment, the query information calculator 410 may calculate the second query information MQᵢ(S) by using the second sub-feature information Q(S) and the pre-trained query matrix W^{Q}ᵢ(V,S)

In this state, the pre-trained query matrix, the first query information, and the second query information may be values corresponding to each of the layers of the DNN network.

In an embodiment, the query information calculator 410 may calculate the first query information MQᵢ(V) by performing an inner product of the first sub-feature information Q(V) and the pre-trained query matrix W^{Q}ᵢ(V,S). Likewise, the query information calculator 410 may calculate the second query information MQᵢ(s) by performing an inner product of the second sub-feature information Q(S) and the pre-trained query matrix W^{Q}ᵢ(V,S).

In an embodiment, the pre-trained query matrix W^{Q}ᵢ(V,S) may be a pre-trained value to indicate the relative importance of the first sub-feature information Q(V) to the second sub-feature information Q(S). Likewise, in an embodiment, the pre-trained query matrix W^{Q}ᵢ(V,S) may be a pre-trained value to indicate the relative importance of the second sub-feature information Q(S) to the first sub-feature information Q(V).

In an embodiment, the pre-trained query matrix W^{Q}ᵢ(V,S) may be a matrix including parameters related to the first sub-feature information Q(V) and the second sub-feature information Q(S), and may be a pre-trained value corresponding to each of the layers of the DNN network.

In operation S1020, the electronic apparatus 200 may obtain key information corresponding to each of the layers of the DNN network.

In an embodiment, the key information MKᵢ(V,S) corresponding to each of the layers may be calculated by the key information calculator 420.

In an embodiment, the key information calculator 420 may calculate the key information MKᵢ(V,S) by using the feature information Kᵢ(V,S) extracted from each of the layers and the pre-trained key matrix W^{K}ᵢ(V,S). In this state, the feature information, the pre-trained key matrix, and the key information may be values corresponding to each of the layers of the DNN network.

In an embodiment, the key information calculator 420 may calculate the key information MKᵢ(V,S) by performing an inner product of the feature information Kᵢ(V,S) extracted from each of the layers and the pre-trained key matrix W^{K}ᵢ(V,S).

In an embodiment, the pre-trained key matrix W^{K}ᵢ(V,S) may be a pre-trained value to indicate the relative importance of the image type V and the sound type S in the feature information Kᵢ(V,S) extracted from in the i-th layer of the DNN network.

In an embodiment, the pre-trained key matrix W^{K}ᵢ(V,S) may be a matrix including parameters related to the image type V and the sound type S, and a pre-trained value corresponding to each of the layers of the DNN network.

In operation S1030, the electronic apparatus 200 may obtain first context information and second context information corresponding to each of the layers of the DNN network.

In an embodiment, the first context information Cᵢ(V) and the second context information Cᵢ(S) may be calculated by the context information calculator 430.

In an embodiment, the context information calculator 430 may calculate the first context information Cᵢ(V) by using the first query information MQᵢ(V) and the key information MKᵢ(V,S). Likewise, in an embodiment, the context information calculator 430 may calculate the second context information Cᵢ(S) by using the second query information MQᵢ(S) and the key information MKᵢ(V,S).

In this state, the first query information, the second query information, the first context information, the second context information, and the key information may be values corresponding to each of the layers of the DNN network.

In an embodiment, the context information calculator 430 may calculate the first context information cᵢ(v) by performing an inner product of the first query information MQᵢ(V) and the key information MKᵢ(V,S). Likewise, in an embodiment, the context information calculator 430 may calculate the second context information Cᵢ(S) by performing an inner product of the second query information MQᵢ(S) and the key information MKᵢ(V,S).

In an embodiment, the first context information cᵢ(v) may be a value indicating a correlation between the first query information MQᵢ(V) and the key information MKᵢ(V,S), and the second context information Cᵢ(S) may be a value indicating a correlation between the second query information MQᵢ(S) and the key information MKᵢ(V,S)_{.}

In this state, for example, when a first context value cᵢ(v) is greater than a second context value Cᵢ(S), it may be determined that the correlation between the first query information and the key information is greater than the correlation between the second query information and the key information, and that the relative importance of the first type V is greater than that of the second type S.

In operation S1040, the electronic apparatus 200 may calculate a weight for each type corresponding to each of the layers of the DNN network.

In an embodiment, the weight AWᵢ for each type corresponding to each of the layers may be calculated by the weight-for-each-type calculator 440.

In an embodiment, the weight-for-each-type calculator 440 may calculate one weight AWᵢ for each type per layers of the DNN network by using the first context information cᵢ(v) and the second context information Cᵢ(S). In another embodiment, the weight-for-each-type calculator 440 may calculate a plurality of weights for each type per layers of the DNN network, for example, a first weight AWᵢ(v) for each type, a second weight AWᵢ(s) for each type, by using the first context information cᵢ(v) and the second context information Cᵢ(S).

In this state, the first context information, the second context information, and the weight for each type may be values corresponding to each of the layers of the DNN network.

In an embodiment, one weight AWᵢ for each type per a plurality of layers may be calculated by dividing the maximum value of the first context information cᵢ(v) and the second context information Cᵢ(S) by a a sum of the first context information cᵢ(v) and the second context information Cᵢ(S).

In another embodiment, the first weight AWᵢ(v) for each type may be calculated by dividing the first context information cᵢ(v) by a sum of the first context information cᵢ(v) and the second context information Cᵢ(S), and the second weight AWᵢ(S) for each type may be calculated by dividing the second context information Cᵢ(S) by a sum of the first context information cᵢ(v) and the second context information Cᵢ(S).

In operation S1050, the electronic apparatus 200 may obtain a final output value corresponding to a preset task by applying a weight for each type calculated in each of the layers of the DNN network.

In an embodiment, the DNN network may obtain a final output value corresponding to a preset task by applying the weight AWᵢ for each type calculated by the weight-for-each-type calculator 440 to each of the layers.

For example, the DNN network may obtain a final output value corresponding to a preset task by multiplying the weight AWᵢ for each type with respect to by the preset weight value wᵢ with respect to the i-th layer of a plurality of layers of the DNN network.

What is claimed is:

1. An electronic apparatus for performing a preset task by using a deep neural network (DNN), the electronic apparatus comprising:
an input interface configured to receive input data of a first type and input data of a second type;
a memory storing one or more instructions; and
a processor configured to execute the one or more instructions stored in the memory to:
obtain first sub-feature information corresponding to the input data of the first type and second sub-feature information corresponding to the input data of the second type;
obtain feature information from each of a plurality of layers of the DNN by inputting the first sub-feature information and the second sub-feature information into the DNN;
calculate a weight for each type corresponding to each of the plurality of layers, based on the feature information, the first sub-feature information, and the second sub-feature information; and
obtain a final output value corresponding to the preset task by applying the weight for each type, in each of the plurality of layers.

2. The electronic apparatus of claim 1, wherein the processor is further configured to:
obtain the first sub-feature information by inputting the input data of the first type into a pre-trained first sub-network; and
obtain the second sub-feature information by inputting the input data of the second type into a pre-trained second sub-network.

3. The electronic apparatus of claim 1, wherein the processor is further configured to:
encode, based on type identification information that distinguishes a type of the input data, the first sub-feature information and the second sub-feature information; and
input the encoded first sub-feature information and the encoded second sub-feature information to the DNN.

4. The electronic apparatus of claim 3, wherein the processor is further configured to encode the first sub-feature information and the second sub-feature information by concatenating the first sub-feature information and the second sub-feature information.

5. The electronic apparatus of claim 1, wherein the processor is further configured to:
obtain first query information corresponding to each of the plurality of layers, based on the first sub-feature information and a pre-trained query matrix corresponding to each of the plurality of layers, wherein the first query information indicates a weight of the first sub-feature information; and
obtain second query information corresponding to each of the plurality of layers, based on the second sub-feature information and the pre-trained query matrix, wherein the second query information indicates a weight of the second sub-feature information,
wherein the pre-trained query matrix comprises parameters related to the first sub-feature information and the second sub-feature information.

6. The electronic apparatus of claim 5, wherein the processor is further configured to obtain key information corresponding to each of the plurality of layers, based on the feature information extracted from each of the plurality of layers and a pre-trained key matrix corresponding to each of the plurality of layers.

7. The electronic apparatus of claim 6, wherein the processor is further configured to:
obtain first context information corresponding to each of the plurality of layers, the first context information indicating a correlation between the first query information and the key information; and
obtain second context information corresponding to each of the plurality of layers, the second context information indicating a correlation between the second query information and the key information.

8. The electronic apparatus of claim 7, wherein the processor is further configured to calculate the weight for each type corresponding to each of the plurality of layers, based on the first context information and the second context information corresponding to each of the plurality of layers.

9. The electronic apparatus of claim 1, wherein the input data of the first type and the input data of the second type comprise at least one of image data, text data, sound data, or video data.

10. A method of operating an electronic apparatus that performs a preset task by using a deep neural network (DNN), the method comprising:
receiving input data of a first type and input data of a second type;
obtaining first sub-feature information corresponding to the input data of the first type and second sub-feature information corresponding to the input data of the second type;
obtaining feature information from each of a plurality of layers of the DNN by inputting the first sub-feature information and the second sub-feature information into the DNN;
calculating a weight for each type corresponding to each of the plurality of layers, based on the feature information, the first sub-feature information, and the second sub-feature information; and
obtaining a final output value corresponding to the preset task by applying the weight for each type, in each of the plurality of layers.

11. The method of claim 10, wherein the obtaining of the first sub-feature information corresponding to the input data of the first type and the second sub-feature information corresponding to the input data of the second type comprises:
obtaining the first sub-feature information by inputting the input data of the first type into a pre-trained first sub-network; and
obtaining the second sub-feature information by inputting the input data of the second type into a pre-trained second sub-network.

12. The method of claim 10, wherein the inputting of the first sub-feature information and the second sub-feature information into the DNN comprises:
encoding the first sub-feature information and the second sub-feature information; and
inputting the encoded first sub-feature information and the encoded second sub-feature information into the DNN.

13. The method of claim 12, wherein the encoding of the first sub-feature information and the second sub-feature information comprises encoding the first sub-feature information and the second sub-feature information by concatenating the first sub-feature information and the second sub-feature information.

14. The method of claim 10, wherein the calculating of the weight for each type corresponding to each of the plurality of layers comprises:
obtaining first query information corresponding to each of the plurality of layers, based on the first sub-feature information and a pre-trained query matrix corresponding to each of the plurality of layers; and
obtaining second query information corresponding to each of the plurality of layers, based on the second sub-feature information and the pre-trained query matrix,
wherein the first query information indicates a weight of the first sub-feature information, and the second query information indicates a weight of the second sub-feature information, and
wherein the pre-trained query matrix comprises parameters related to the first sub-feature information and the second sub-feature information.

15. The method of claim 14, wherein the calculating of the weight for each type corresponding to each of the plurality of layers further comprises obtaining key information corresponding to each of the plurality of layers, based on the feature information extracted from each of the plurality of layers and a pre-trained key matrix corresponding to each of the plurality of layers.

16. The method of claim 15, wherein the calculating of the weight for each type corresponding to each of the plurality of layers further comprises:
obtaining first context information corresponding to each of the plurality of layers, the first context information indicating a correlation between the first query information and the key information; and
obtaining second context information corresponding to each of the plurality of layers, the second context information indicating a correlation between the second query information and the key information.

17. The method of claim 16, wherein the calculating of the weight for each type corresponding to each of the plurality of layers further comprises calculating the weight for each type corresponding to each of the plurality of layers, based on the first context information and the second context information corresponding to each of the plurality of layers.

18. The method of claim 10, wherein the input data of the first type and the input data of the second type comprise at least one of image data, text data, sound data, or video data.

19. A non-transitory computer-readable recording medium having recorded thereon a program for executing, on a computer, the method of claim 10.
